(19) United States
(12) Patent Application Publication
(10) Pub. No.: US 2020/0337401 A1
(43) Pub. Date: Oct. 29, 2020

(54) CONTINUOUS STRAND HAVING WATER WASHABILITY AND SEPARABILITY DURING CURLING PROCESS AND COMPRISING FILAMENTS BONDED TO EACH OTHER BY THERMAL SURFACE BONDING, WET LOOK WIG USING SAME, AND METHOD FOR MANUFACTURING SAME

(71) Applicant: YG CHEM CO., LTD., Seoul (KR)

(72) Inventor: Hae Ju LEE, Seoul (KR)

(73) Assignee: YG CHEM CO., LTD., Seoul (KR)

(21) Appl. No.: 16/929,517

(22) Filed: Jul. 15, 2020

Related U.S. Application Data
(63) Continuation of application No. PCT/KR2019/000661, filed on Jan. 16, 2019.

(30) Foreign Application Priority Data
Jan. 16, 2018 (KR) 10-2018-0005513

(51) Int. Cl. A41G 3/00; B29D 99/00

(52) U.S. Cl. CPC A41G 3/0083; B29D 99/0078; A41G 3/0041

(57) ABSTRACT

Provided are a strand which extends in one direction and includes 30 to 8,000 strands of thermoplastic polymer filaments including an amorphous organic polymer, a semi-crystalline organic polymer, or an alloy thereof, wherein each of the filaments has a fineness of 10 to 100 denier and the filaments are bonded to one another by surface fusion; and a method of preparing the same. Provided also are a weft using the strand, a wet look wig using the same, and a method of preparing the wig. When the strand is used, the filaments thereof may be bonded to one another through thermal surface-fusion using thermal properties of the filaments even without using a conventional water-soluble adhesive (binder), and thus a wet look wig washable with water even when worn by a user may be prepared by a simple and economical method.

### CROSS-REFERENCE TO RELATED APPLICATIONS AND PRIORITY

This application is a continuation of PCT/KR2019/000661, filed on Jan. 16, 2019, which claims priority to and the benefit of Korean Patent Application No. 10-2018-0005513, filed on Jan. 16, 2018, in the Korean Intellectual Property Office. The disclosures of the above applications are incorporated herein by reference.

### TECHNICAL FIELD

The present disclosure relates to a continuous strand formed of thermally fused filaments, a weft for preparing a wig using the strand, wet-look wigs using the strand, and a method of preparing the strand. More particularly, the present disclosure relates to a continuous strand, a weft for preparing a wig and all wet-look wigs (including all wet-look wigs, wet-look weaves, and wet-look braids) using the strand, and a method of preparing the strand, wherein the continuous strand is not a conventional short strand formed of filaments bonded to one another by being separately and non-continuously treated with a chemical adhesive during wig preparing processes but has water-washability and separability during a curling process and is formed of filaments bonded to one another by thermal surface fusion.

### BACKGROUND

Various wig products have been presented according to different races, ages, and genders, where wigs are selected to have particular forms or shapes according to their purpose of use.

A wet-look hair style, which is one of the wig hair styles for Afro hair, refers to a curly hair style that is wet shiny like after shower and is one of the popular wig hair styles among black peoples. However, the wig for expressing wet-look has a certain limitation in expanding its sales volume because its cost is high due to the complicated manufacturing process.

So far, a chemical bonding method that binds thermoplastic polymer filaments of a predetermined amount using a chemical adhesive has been used to express the wet-look. This method includes manually measuring the filaments at a predetermined amount to prepare a bundle, impregnating the bundle in a water-soluble adhesive solution, and drying the bundle to bind the filaments at a predetermined amount. However, this method is an inefficient method which requires very complicated process and lots of manpower. A chemical bonding process in the method is described in more detail as follows. First, i) a false hair yarn in a tow state including several thousand filaments to several ten thousand filaments provided by a false hair yarn manufacturer is tailored to a desired length and a desired amount, and ii) the filaments are combed using a hackle. Then, iii) the filaments are measured at a predetermined amount to produce a style in the required thickness, and iv) one ends of the filaments are connected to a connecting band by sewing to prepare a weft. Subsequently, v) after winding the weft on a pipe, the weft is heat-treated (dry heat-treatment or wet heat-treatment) as a curling process that form curls on the weft, and, lastly, vi) the hair style is finished with a cosmetic touch-up.

The v) curling process may be classified into two types. FIG. 1 is a conceptual view for illustrating a vertical winding method of forming relatively large curls as one example of the curling process. Referring to FIG. 1(a), a weft 100 used in the curling process includes a connecting band 10; and a plurality of filaments 12 having one ends connected to the connecting band 10 by sewing. As shown in FIG. 1(a), first, the weft 100 prepared by connecting one ends (parts corresponding to hair roots when the wig is worn) of the filaments 12 to the connecting band 10 is folded in multiple layers, e.g., 4 to 8 layers, in a direction where the connecting band 10 is folded. Here, when the connecting band 10 is folded in multiple layers, it is preferably to fold the filaments 12 neatly and orderly while being careful not to tangle the filaments 12. The weft 100 folded in this manner is wound on a metal pipe 14, e.g., an aluminum pipe 14, having a relatively large diameter in a vertical direction shown by an arrow 16, i.e., a direction perpendicular to a length direction of the pipe 14 (where the longitudinal direction of the connecting band 10 is positioned parallel to the longitudinal direction of the pipe 14), and such winding state is fixed. Subsequently, in the fixed state, the weft 100 is thermally set for a predetermined time to form curls thereon, and the weft 100 is removed from the pipe 14. Next, the weft 100 is unfolded to separate and organize the filaments such that the filaments located at an appropriate length are bundled and aligned in parallel, and the weft 100 in this organized state is transferred to an impregnating process in an aqueous binder solution and a drying process. FIG. 1(b) is a schematic view that illustrates the weft 100 having relatively large curls formed thereon in this manner. Referring to FIG. 1(b), units of the filaments 12 having relatively large curls formed thereon are organized in a state of being separated from one another.

FIG. 2 is a conceptual view for illustrating a spring winding method for forming relatively small curls. Referring to FIG. 2(a), the filaments 12 located at an appropriate length when the weft 100 is unfolded are spirally and tightly wound on a metal pipe 16, e.g., an aluminum pipe 16, having a relatively small diameter as shown in the drawing, and such winding state is fixed. Subsequently, in the fixed state, the weft 100 is thermally set for a predetermined time to form relatively small curls thereon, and the weft 100 is removed from the pipe 16. FIG. 2(b) is a schematic view illustrating the weft 100 on which relatively small and fine curls are formed in this regard. Referring to FIG. 2(b), units of the filaments 12 having relatively fine and small curls formed thereon are organized in a state of being separated from one another. Thereafter, the weft 100 in this organized state is transferred to an impregnating process in an aqueous binder solution and a drying process.

The chemical bonding process that bind thermoplastic polymer filaments of a certain number of filaments in a weft using a chemical adhesive to produce wet-look is mainly performed in the vi) cosmetic touch-up process among the i) to vi) processes. Particularly, in the vi) process, the weft having a predetermined length (e.g., 2 to 4 m) is unfolded after the iv) and v) processes, the filaments organized and curled as shown in FIG. 1(b) or 2(b) are impregnated in an aqueous binder solution while maintaining the bundled state as shown in FIG. 1(b) or 2(b) and then dried, whereby a predetermined number of the filaments are bonded to one another as shown in FIG. 1(b) or 2(b) to produce a wet-look effect. Particularly, the weft organized in such manner is impregnated in an aqueous adhesive solution including a water-soluble adhesive (a solids content of about 10 wt % to about 30 wt %) diluted to about 0.3 wt % to about 20 wt %, more preferably, about 1.5 wt % to about 10 wt % for about 1 minute to about 10 minutes and is taken out of the solution. Then, a predetermined number of the filaments forming curls are bonded to one another to form a strand and dried in a hot-air drier for about 30 minutes to about 1 hour, thereby completing the wet-look treatment.

However, the vi) cosmetic touch-up process and a task of impregnating the curled weft in an aqueous binder solution and drying the weft are performed manually are very labor-intensive and time-consuming. In the vi) cosmetic touch-up process, when the filaments are impregnated in an aqueous binder solution and dried without being bundled or collected at a predetermined amount separately, the filaments are not produced in the state of being separated at a predetermined amount, and thus a beautiful esthetic wet-look may not be achieved.

Afro wig products are classified into whole wigs, braids, and weaves depending on how the wig is worn. A whole wig is a type that may be attached to and detached from hair, a braid is a type that is connected to hair of the user by braiding, and a weave is a type that is sewed with thread or attached with an adhesive to a so-called “corn row” after preparing the corn row style using curly hair of the user. Whole wigs are not in high demand due to the poor cost efficiency, and most commonly used products are weaves and braids. However, weaves and braids are worn for 2 to 6 weeks and then removed or detached from hair, which makes them difficult to be washed. The washing is performed without water by using dry shampoo or no-rinse shampoo, but the washing may not be completely clean and may be unsanitary. In order to resolve this problem, antibacterial wig yarns have been developed, but these still may not fundamentally resolve the hygiene problem.

However, wet-look wigs prepared by using a strand formed of filaments bonded by a chemical adhesive may not be washed with water because when the wig is washed with water (e.g., shower) while being worn by the user, the aqueous adhesive (binder) is washed out with water, and thus a bonding (or fusion) state between the filaments may not be maintained. Thus, the wig prepared by using a strand formed of filaments bonded by a conventional water-soluble adhesive may be unsanitarily worn for a long period of time, and the bond between the filaments may be loosen in the rain, which results the wig to appear messy and dirty.

Therefore, there is a need of a strand product formed of filaments which enables simple and economic manufacture of a water-washable wet-look wig.

### SUMMARY

The present disclosure may be used in the manufacture of a strand, a weft for preparing a wig using the strand, and wet-look wigs using the strand.

Provided is a strand formed of filaments which enables simple and economic manufacture of a water-washable wet-look wig.

Provided is a weft for preparing a wet-look wig that may be water-washable and may be simply and economically manufactured.

Provided are wet-look wigs (including all wet-look wigs, wet-look weaves, wet-look braids, or wet-look curly pieces) including or not including a weft that is water-washable and may be simply and economically manufactured.

Provided is a method of preparing the strand.

According to an aspect of an embodiment of the present disclosure, provided is a strand extended in one direction, the strand including 30 to 8,000 thermoplastic polymer filaments including an amorphous organic polymer, a semi-crystalline organic polymer, or an alloy thereof, wherein each of the filaments has a fineness of 10 denier to 100 denier, and the filaments are arranged parallel to one another side by side and are bonded to one another by surface fusion.

According to another aspect of an embodiment of the present disclosure, provided is a weft for preparing a wig, the weft including: a connecting band extended in one direction; and a plurality of strands having one ends connected to the connecting band, wherein the one ends of the strands are sequentially connected to a side of the connecting band in a direction the connecting band is extended, wherein the strands are extended in one direction, and each of the strands includes 30 to 8,000, or, for example, 60 to 4,000, thermoplastic polymer filaments including an amorphous organic polymer, a semi-crystalline organic polymer, or an alloy thereof, wherein each of the filaments has a fineness of 10 denier to 100 denier, and the filaments are bonded to one another by surface fusion.

In one embodiment of the present disclosure, a cross-section of the strand may be circular, elliptical, triangular, rectangular, square, or irregular.

In one embodiment of the present disclosure, the strands having a circular cross-section may have a rotational twist.

In one embodiment of the present disclosure, the strands may have curls in a direction the strands are extended.

In one embodiment of the present disclosure, the strands having curls may be separated from one another in the weft.

According to another aspect of an embodiment of the present disclosure, provided are wigs (including all wet-look wigs, wet-look weaves, and wet-look curly pieces) including or not including the strand according to an embodiment of the present disclosure or the weft according to another embodiment of the present disclosure.

According to another aspect of an embodiment of the present disclosure, provided is a method of preparing a wig including a weft, the method including: connecting one ends of a plurality of strands to a connecting band extended in an extending direction, wherein the one ends of the strands are sequentially connected to a side of the connecting band along the extending direction of the connecting band to form a weft; folding the weft in a plurality of layers in the extending direction of the connecting band; winding the weft folded in this manner on a pipe, wherein the strands wind the pipe such that an extending direction of the strands is perpendicular to an extending direction of the pipe when the extending direction of the connecting band of the weft is positioned parallel to the extending direction of the pipe; and forming curls on the strands of the weft by heat-treating the weft while the strands are wound on the pipe (as described above) and removing the pipe.

According to another aspect of an embodiment of the present disclosure, provided is a method of preparing a wig, the method including: connecting one ends of a plurality of strands to a connecting band extended in an extending direction, wherein the one ends of the strands are sequentially connected to a side of the connecting band along the extending direction of the connecting band to form a weft;

winding the weft on a pipe, wherein the strands of the weft are spirally wound on the pipe along an extending direction of the pipes; and forming curls on the strands of the weft by heat-treating the weft while the strands are wound on the pipe (as described above) and removing the pipe.

In some embodiments of the present disclosure, the strands on which curls are formed may be separated from one another.

In some embodiments of the present disclosure, the method may further include sewing the weft having the strands on which curls are formed on a cap to prepare a wig.

In some embodiments of the method of preparing a wig according to the present disclosure, when the strand according to an aspect of an embodiment is used as the strands, the impregnating the strands on which the curls are formed in an adhesive solution and drying the strands may be omitted. Also, the method may be significant in terms of innovatively simplifying the process of forming wet-look curls. As the strands may be separable from one another, a plurality of curls may be simultaneously prepared with one curl winding.

According to another aspect of an embodiment of the present disclosure, provided is a method of preparing a strand including a plurality of thermoplastic polymer filaments including an amorphous organic polymer, a semi-crystalline organic polymer, or an alloy thereof, the method including:

withdrawing the plurality of filaments 19 from a first winding roll 22 by rotating 21 the first winding roll 22 on which the plurality of filaments 19 measured to a desired amount are separately wound;

forming the strand 25 by bundling the plurality of the filaments 19, and then bonding the filaments 19 by conveying the strand 25 through a heat-fusion section 31 heated to a softening point of the filaments 19 or higher to surface-fuse the filaments 19 bundled in the strand one another; and

rewinding the strand 25 including the filaments 19 bonded to one another by the surface-fusion on a second winding roll.

In one embodiment of the present disclosure, the method may further include equipping a tunnel-type mold 33 having an opening of a desired cross-sectional shape in the heat-fusion section 31 to induce a cross-section of the strand 25 passing through the heat-fusion section 31 to have the same cross-section shape of the opening of the mold 33.

In one embodiment of the present disclosure, the method may further include controlling a tension applied to the filaments 19 of the strand 25 by controlling a rotation speed of a pair of first rolls 27 equipped outside an inlet of the heat-fusion section 31 and a rotation speed of a pair of second rolls 29 equipped outside an outlet of the heat-fusion section 31.

In one embodiment of the present disclosure, the method may further include applying a spiral rotational twist to the strand 25 including the plurality of filaments 19 by rotating the first winding roll 22 in a direction 20 different from the direction in which the filaments 19 are withdrawn from the first winding roll 22.

The strand for a wig according to the present disclosure induces bonds between the thermoplastic filaments of a predetermined amount previously measured by surface-fusion between the filaments using thermal characteristics of the filaments without using a chemical adhesive (binder). Thus, when a wet-look wig product is prepared using the strand according to the present disclosure, the following effects may be achieved.

1) Since the filaments bonded to one another in each of the strands according to the present disclosure are already measured to a predetermined amount, the filaments do not need to be manually measured in a curling process, and since each of the strands thermally bonded to one another has separability, the curling process is simple, and the several strands may be simultaneously processed with one curling process. In the strands according to the present disclosure, the filaments of an already-measured predetermined amount are bonded to one another, and thus the strands may be in a state where the strands (more accurately, a predetermined amount of the filaments in one of the strands) are separated apart at a predetermined interval after cutting the strands to a desired length to prepare a weft, setting curls to the weft, and removing a curling pipe. In this regard, when the weft prepared using the strands according to the present disclosure is separated from the curling pipe, preparation of a wet-look wig may be finished. Also, even when forming small curls as shown in FIG. 2, multiple strands are wound simultaneously on one curling pipe and heat-treated to form the curls without forming a weft, and then the strand is separated from the pipe. In this manner, it is possible to easily produce curled strands that may be used for producing a wet look wig. Therefore, the strand according to the present disclosure may innovatively contribute in productivity improvement of a wig preparation process.

Also, when a wet-look wig is prepared using the strands according to the present disclosure, a complicated and consuming processes like a separation treatment step for manually bundling the filaments at a predetermined amount in the cosmetic touch-up process, and a water-soluble adhesive impregnation and drying process may be omitted. Thus, when a wet-look wig is prepared using the strands according to the present disclosure, the highly labor-intensive and time-consuming processes may be omitted.

Accordingly, when the strands according to the present disclosure are used, a preparation process of a wet-look wig may be significantly simplified and the labor force may be reduced, which may increase the product competitiveness.

2) Since a chemical adhesive (binder) does not need to be used in the preparation process of a wet-look wig by using the strands according to the present disclosure, the wig thus prepared does not have problems even when in the rain, unlike the conventional wet-look wig. Thus, since the user may take a shower and dry hair using a hair drier while wearing the wet-look wig prepared by using the strands according to the present disclosure and may wash the wig with soap and water after taking it off if necessary, the wig not only has hygienic usability but also has good environmental resistance as it is not affected by the external environment in case of rain, unlike the conventional product.

3) Since the conventional wet-look wig prepared by a bonding method using a water-soluble adhesive has curls formed in the state in which the filaments are tightly wound on a pipe and accompanies an impregnation process in a water-soluble adhesive and a drying process, a cross-section of a strand (corresponding to a strand of the present disclosure) formed of the bonded filaments is flat. However, the strand according to the present disclosure is fused and bonded while maintaining a cross-sectional shape already formed in the preparation process and is wound for curl setting in this state, and thus the cross-sectional shape may be maintained. Therefore, the strand according to the present disclosure may have various cross-sectional shape such as a circle, a rectangle, or a square, and thus various hair styles may be expressed according to market trends. In particular, although a wet-look wig having a circular cross-section has a significant aesthetic effect, mass-production of the wig has been difficult to manufacture the wig economically by manual labor using a conventional chemical adhesive (binder).

### BRIEF DESCRIPTION OF DRAWINGS

FIG. 1 is a conceptual view that illustrates a vertical winding method for forming relatively large curls in a weft preparation process;

FIG. 2 is a conceptual view that illustrates a spring winding method for forming relatively small curls in a weft preparation process;

FIG. 3 is a side view of a weft prepared using a strand according to an embodiment of the present disclosure;

FIG. 4 is a schematic flowchart that illustrates a method of preparing the strand according to an embodiment of the present disclosure;

FIG. 5 is an image of a weft having curls prepared using the strand according to an embodiment of the present disclosure;

FIG. 6 is a conceptual view that illustrates a plurality of strands having separability without forming a weft, the strands continuously wound on a pipe 39; and

FIG. 7 is an image of strands according to another embodiment of the present disclosure, the strands having curls.

### DETAILED DESCRIPTION OF EMBODIMENTS

Hereinafter, strands and methods of preparing the same according to one or more embodiments of the present disclosure will be described in detail. However, it should be understood that embodiments described herein should be considered in a descriptive sense only. Thus, it will be understood by one of ordinary skill in the art that various amendments or modifications may be made to the one or more exemplary embodiments of the present disclosure without departing from the spirit and scope. In description of the present disclosure, detailed descriptions about commonly known functions or elements will be omitted in order to avoid obscuring the main concept of the present disclosure.

As used herein, the terms “about,” “substantially,” or the like are to denote numerical values proximate to the numerical values modified by the terms when permissible errors related to inherent preparation and material are provided. The terms are used to prevent unscrupulous infringers from unjustly using the disclosed content including an accurate or absolute numerical value and to provide better understanding of the present disclosure.

As used herein, filaments may include both monofilaments and multifilaments. When multiple monofilaments are integrated to make a multifilament, twists may be added or not added to the multifilament according to the hair style of a wig as the final product.

According to an embodiment of the present disclosure, a strand is extended in one direction. The strand may include 30 to 8,000, for example, 40 to 4,000, 60 to 4,000, or 200 to 2,000 thermoplastic polymer filaments including an amorphous organic polymer, a semi-crystalline organic polymer, or an alloy thereof. Each of the filaments has a fineness of 10 denier to 100 denier, for example, 20 denier to 80 denier, and the filaments are generally arranged parallel to one another side by side and are bonded to one another by surface fusion or adhesion. In this regard, when a weft or a wig is prepared using the strand according to the present disclosure, the filaments in a strand are bonded to one another by surface fusion between the filaments using thermal characteristics of the thermoplastic filaments without using a chemical adhesive, and thus the strand may be conveniently used in a process of preparing a wet-look wig. As used herein, the term “denier” refers to a weight (unit: g) of 9000 m of a filament in the sampled state itself from the strand regardless of having spiral rotational twists.

Examples of a polymer material that may be used in preparation of the filaments may preferably include an amorphous organic polymer or a crystalline organic polymer having a low degree of crystallinity in terms of easing surface thermal fusion, but examples of the polymer material are not limited thereto. For example, an amorphous organic polymer or a semi-crystalline organic polymer having a crystallinity of 30%, preferably, 20% or less, may be advantageously used. Examples of the polymer material may include polyvinyl chloride (PVC), polyvinylidene chloride (e.g. under the trade name MODACRYL), polyacrylonitrile (PAN), an acrylic resin, polycarbonate (PC), polymethyl methacrylate (PMMA), polystyrene (PS), an acrylonitrile-butadiene-styrene (ABS) resin, polyester, a styrene-acrylonitrile (SAN) resin, an acrylonitrile-styrene-acrylate (ASA) resin, polyacrylate (PAR), a glycol-modified polyethylene terephthalate (PET) resin, polyphenylene sulfide (PPS), or an alloy of two or more of these polymers. Examples of the alloy may include an alloy of PC and ABS, an alloy of PC and PET, or an alloy of PC and PMMA. When a thermoplastic material capable of surface fusion in a short period of time at a glass transition temperature is selected among the examples of the polymer, and when temperature and tension conditions needed for the surface fusion appropriate to characteristics of the selected material are controlled, the thermoplastic material may be used in preparation of the strand according to an embodiment of the present disclosure.

As a material having a low crystallinity, PPS or an alloy including an amorphous polymer and a crystalline polymer at an appropriate ratio such as 20 to 80 weight percentage (wt %) of an amorphous polymer and 80 wt % to 20 wt % of a crystalline polymer is a representative example.

A cross-section of the strand may be circular, elliptical, triangular, quadrilateral such as rectangular or square, or irregular. A strand having a circular cross-section may have rotational twists. The strand may have curls in its extended direction.

A diameter of the circular cross-section may be in a range of 0.2 cm or greater to 3.0 cm or less, for example, 0.5 cm or greater to 2.0 cm or less. When a cross-section is elliptical, a diameter D is defined by an average value of the shortest diameter and the longest diameter. When a cross-section of the strand is quadrilateral or triangular, a length of one side of the quadrilateral or triangle may be in a range of 0.2 cm or greater to 3.0 cm or less, for example, 0.5 cm or greater to 2.0 cm or less. When the cross-section of a strand is irregular, the cross-sectional area may be controlled to a degree similar to a cross-sectional area of the strand having a circular, elliptical, quadrilateral, or triangular cross-section.

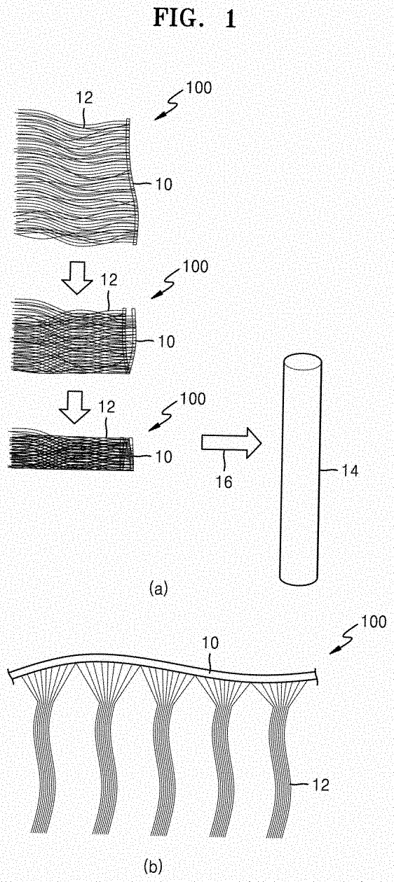

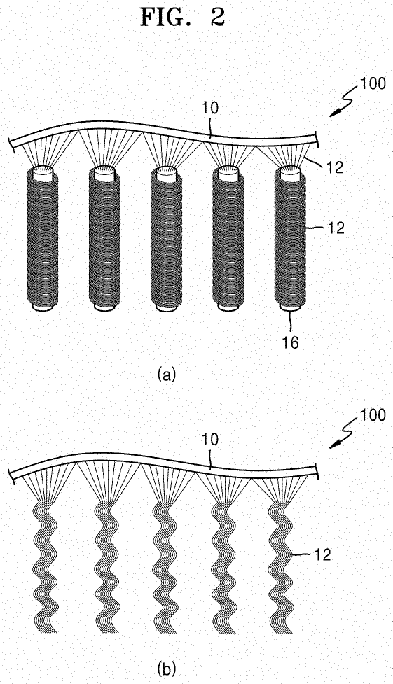

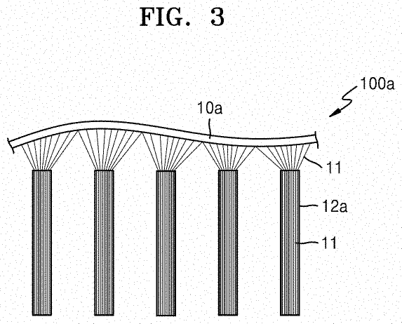

FIG. 3 is a side view of an example of a weft 100a for preparing a wig, in which the weft 100a is prepared by using the strand according to an embodiment of the present disclosure. Referring to FIG. 3, the weft 100a includes a connecting band 10a extended in one direction; and a plurality of strands 12a of which one ends are connected to the connecting band 10a, wherein the one ends of the strands 12a are sequentially connected to a side of the connecting band 10a in the direction the connecting band 10a is extended. The strands 12a are generally perpendicularly connected to the connecting band 10a in one direction, and typically connected by sewing. The bonding state of filaments 11 in the strands 12a at a connecting part may be disassembled to ease connecting the filaments 11 to the connecting band 10a by sewing. The above description may also be applied to the structures of the strands 12a and the filaments 11 in the strands 12a. Moreover, since the strands 12a each measured to a predetermined amount are separated from one another, and thus when a curling pipe is removed in a curling process, the strands 12a having curls and separated from one another (as in the illustrated state of FIG. 1(b) or FIG. 2(b)) may be formed. Therefore, when the curling pipe is removed after the curling process, a wet-look weft and a wet-look wig using the weft may be obtained without a water-soluble adhesive coating and drying process done by a manual labor being performed.

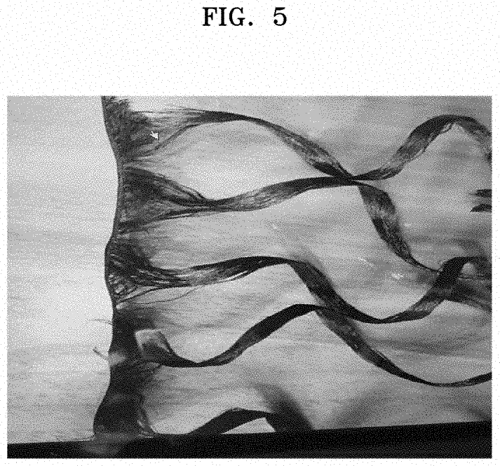

FIG. 5 is an image of a weft according to an embodiment of the present disclosure. Referring to FIG. 5, it may be confirmed that the strands in the weft have curls formed through a curling process, and the strands are separated from one another.

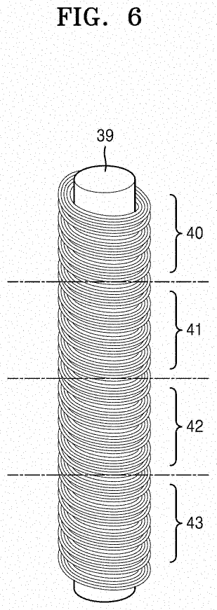

When a wet-look wig is prepared using the strand according to the present disclosure, a plurality of strands may be used in a curling process as they are instead of performing a curling process after forming the weft. FIG. 6 is a conceptual view that illustrates a plurality of strands having separability are continuously wound on a pipe 39 without forming a weft. Referring to FIG. 6, for example, four strands 40, 41, 42, and 43 are continuously wound on the pipe 39 at the same time. After heat-treating the strands 40, 41, 42, and 43 in this state and removing the pipe 39, when the strands 40, 41, 42, and 43 are separated, a plurality of strands having curls may be easily obtained at the same time. In this regard, since the strand according to the present disclosure has separability, when a plurality of the strands, for example, 2 to 20 strands, are heat-set in the state of being wound parallel to one another on the pipe 39 at the same time, the strands are separated from one another without interruption, which allows a curling task to be performed with good productivity by producing many spiral curls or threaded curls at the same time. Thus, when the strand according to the present disclosure is used, labor may be significantly decreased compared to a case when only one strand without separability is wound on one pipe and heat-treated as in a conventional manner.

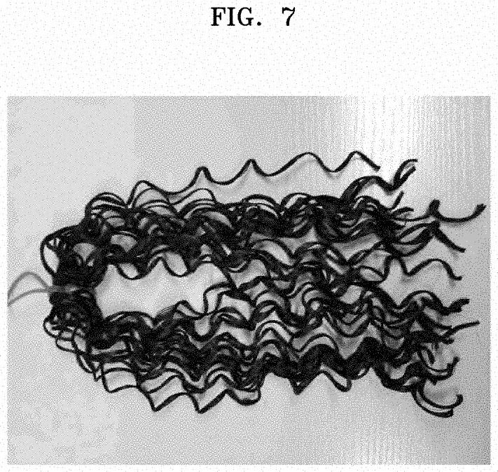

FIG. 7 is an image of multiple strands having curls formed in the simple manner as described above. When the strand having such curls is braided to real hair of the user, a wet-look hair style may be easily and conveniently produced.

When the strand according to the present disclosure having the structural characteristic is used, a coating and drying process using a water-soluble adhesive by manual labor may be omitted, and thus a wet-look wig may be simply and economically obtained.

A method of preparing a wig according to another embodiment of the present disclosure is a method of preparing a wet-look wig having relatively large curls. The method, which does not include a coating and drying process using a water-soluble adhesive, includes connecting one ends of a plurality of strands to a connecting band extended in an extending direction, wherein the one ends of the strands are sequentially connected to a side of the connecting band along the extending direction of the connecting band to form a weft; folding the weft in a plurality of layers in the extending direction of the connecting band; winding the weft on a pipe while the weft are folded in this manner, wherein the strands wind the pipe such that an extending direction of the strands is perpendicular to an extending direction of the pipe when the extending direction of the connecting band of the weft is positioned parallel to the extending direction of the pipe; and forming curls on the strands of the weft by heat-treating the weft while the strands are wound on the pipe as described above and removing the pipe.

A method of preparing a wig according to another embodiment of the present disclosure is a method of preparing a wet-look wig having relatively small and fine curls. The method, which does not include a coating and drying process using a water-soluble adhesive, includes connecting one ends of a plurality of strands to a connecting band extended in an extending direction, wherein the one ends of the strands are sequentially connected to a side of the connecting band along the extending direction of the connecting band to form a weft; winding the weft on a pipe, wherein the strands of the weft are spirally wound on the pipe along an extending direction of the pipes; and forming curls on the strands of the weft by heat-treating the weft while the strands are wound on the pipe as described above and removing the pipe.

The methods may further include preparing a wig by sewing the weft including the strands having relatively large curls or relatively small and fine curls thus obtained on a cap or other processes.

When the strand according to the present disclosure is used as strands in the method of preparing a wig according to the present disclosure, it is advantageous that a process of impregnating the strands having the curls formed thereon in an adhesive solution and a process of drying the strands may be omitted.

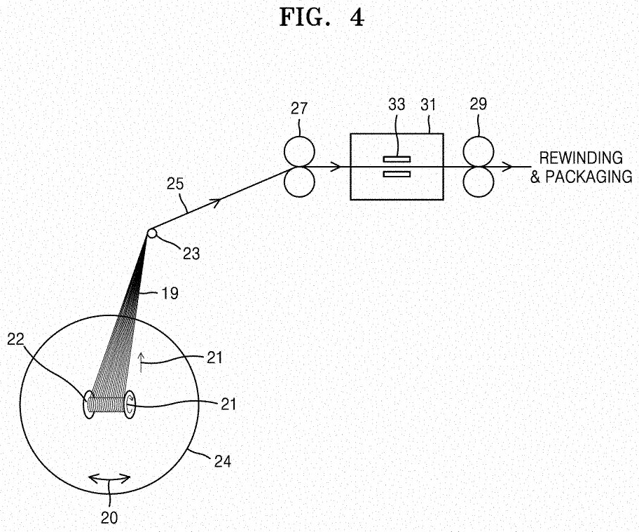

Next, a method of preparing the strand according to an embodiment of the present disclosure having the structural characteristic described above will be described in detail with reference to FIG. 4.

FIG. 4 is a schematic flowchart that illustrates a continuous method of preparing a strand according to another embodiment of the present disclosure.

First, a first winding roll 22, on which a plurality of filaments 19 measured to a desired amount are separately wound, is rotated 21 to withdraw the plurality of filaments 19 from the first winding roll 22. Here, spiral rotational twists may be applied to a strand 25 including the plurality of filaments 19 by rotating the first winding roll 22 in a direction 20 different from the withdrawing direction of the filaments 19 from the first winding roll 22. For example, a circular disc 24 on which the first winding roll 22 is disposed may be rotated in a direction indicated by the reference number ‘20’ in the drawing to apply the spiral rotational twists.

The filaments 19 may be monofilaments or multifilaments. When the monofilaments are multiplexed or doubled to make multifilaments, twists may or may not be applied according to the purpose of use.

The filaments 19 may have continuous crimp texture of, for example, 2 mm to 15 mm by passing a crimp machine. Alternatively, the filaments 19 may be self-textured using a residual shrinkage.

In FIG. 4, a situation of preparing a strand by arranging one first winding roll 22 on one circular disc 24 is illustrated for clarity. However, embodiments of the present disclosure are not limited thereto.

A tunnel-type mold 33 having an opening with a desired cross-sectional shape is equipped in a heat-fusion section 31 so that a cross-sectional shape of the strand 25 passing through the heat-fusion section 31 may be induced to the cross-sectional shape, for example, a circle, a triangle, or a rectangle, of the opening of the mold 33.

A rotation 20 speed of the circular disc 24 may be controlled to apply spiral rotational twists of 5 rpm (rotations per meter) to 230 rpm, for example, 5 rpm to 150 rpm or 15 rpm to 80 rpm, to the strand 25, and thus the strand 25 may be transferred to the heat-fusion section 31 located downstream while maintaining the circular cross-section of the strand 25. When the strand 25 is transferred to the heat-fusion section 31 without spiral rotational twists applied thereto, for example, strands bonded in a flat state of a rectangular cross-section may be obtained by pressing of the tunnel-type mold 33.

After bundling the plurality of filaments 19 using a guide roll 23 to form a strand 25, the strand 25 is passed through the heat-fusion section 31 heated to a softening point or higher of the filaments 19 to bond the filaments 19 which have been bundled to the strand 25 by surface fusion. A temperature of the heat-fusion section 31 may be a softening point of the polymer forming the filaments 19 or higher, for example, may be set 10° C. to 40° C. higher or 20° C. to 30° C. higher than the softening point. In general, the higher the temperature, a retention time passing through the heat-fusion section 31 may be reduced, which in turn may increase productivity.

A tension applied to the filaments 19 of the strand 25 and/or the retention time in the heat-fusion section 31 may be controlled by adjusting a rotation speed of a pair of first rolls 27 equipped outside an inlet of the heat-fusion section 31 and a rotation speed of a pair of second rolls 29 equipped outside an outlet of the heat-fusion section 31.

The tension and/or the retention time of the heat-fusion section 31 directly affect surface fusion of the plurality of filaments 19 constituting the strand 25. When a rotation speed of the second rolls is higher than a rotation speed of the first rolls 27, the tension may increase which contributes to the surface fusion by increasing adherence between the filaments, but when a rotation speed of the second rolls 29 is too high, the strand 25 may be stretched, and when a rotation speed of the second rolls 29 is too low, adherence between the filaments decreases, and thus an esthetic sense of wet-look may decrease. Typically, a rotation speed of the second rolls 29 may be controlled to be higher than a rotation speed of the first rolls 27 by 2% to 15% or lower, for example, 5% to 10%. For example, a horizontal length and a vertical length of a rectangular cross-section of the strand may be controlled by controlling the total denier of the filaments in each of the strands and a tension applied to the strand by a rotation speed difference of the first rolls 27 and the second rolls 29.

The strand 25 according to an embodiment of the present disclosure formed of the filaments 19 bonded to one another by surface fusion may be rewound on a second winding roll (not shown), and then the strand 25 is released in the opposite direction to be cut in an appropriate length, and packaged.

When the strand of the present disclosure in which the filaments bonded to one another by thermal surface fusion as obtained by the method described in detail above is utilized to produce a wig, a conventional bonding process using a chemical adhesive which is complicated and labor-intensive may be omitted. Thus, the strand which has water-washability and thus allows a wet-look wig with significantly improved wearing convenience may be economically and simply manufactured.

The present disclosure will now be described in more detail with reference to the following examples. However, these examples are not intended to limit the scope of the present disclosure.

### Example 1

Three-hundred (300) PVC monofilaments each having a fineness of 50 denier were measured, taken up, and wound on a winding roll. Thirty (30) winding rolls were mounted on a supply die. The monofilaments were released and withdrawn from the winding rolls. Here, the 300 monofilaments being withdrawn from one of the winding rolls were collected and passed through a guide roll to come out as one strand. Thus, a total of 30 strands were passed through a pair of first nip rolls in parallel. The strands running in parallel were passed through a hot air circulation tunnel (having a tunnel length of about 2 m to about 10 m) in which a temperature was maintained constantly at about 95° C. to melt-bond surfaces of the monofilaments in each of the strands, and thus 30 continuous bonded strands were simultaneously formed. A pair of second nip rolls was equipped outside of an outlet of the hot air circulation tunnel. A tension was applied to the monofilaments by using a speed difference between the first nip rolls and the second nip rolls to assist adherence and melt-fusion between the monofilaments heated to a temperature close to the softening point. Running speeds of the first and second nip rolls were 25 meters per minute (mpm) and 25.5 mpm, respectively.

Lastly, thus prepared 30 strands formed of 300 monofilaments were arranged in parallel side by side, and the upper ends of the 30 strands were connected by sewing to a connecting band to obtain a weft having a width of 30 cm formed of the 30 strands.

### Comparative Example 1

False hair yarns (in a state of tow) each formed of 300 PVC monofilaments each having a fineness of 50 denier were cut to be 30 cm in length, and the yarns were divided and weighed into 30 bundles, each bundle having a weight of 0.52 g/300 F. These bundles were immersed in a 5 wt % aqueous binder solution (Wet-look Binder 360, SP KOSTECH) for about 10 minutes and dried in a hot air drier of about 85° C. for about 1 hour to prepare a strand bonded by the adhesive.

Lastly, thus prepared 30 strands were arranged in parallel side by side, and the upper ends of the 30 strands were connected by sewing to a connecting band to obtain a weft having a width of 30 cm formed of the 30 strands.

### Example 2

600 impact-resistant PMMA monofilaments each having a fineness of 45 denier were measured, taken up, and wound on a winding roll. 30 winding rolls were mounted on a supply die. The monofilaments were released and withdrawn from the winding rolls. Here, the 600 monofilaments being withdrawn from one of the winding rolls were collected and passed through a guide roll to come out as one strand. Thus, a total of 30 strands were passed through a pair of first nip rolls in parallel. The strands running in parallel were passed through a hot air circulation tunnel (having a tunnel length of about 2 m to about 10 m) in which a temperature was maintained constantly at about 105° C. to melt-bond surfaces of the monofilaments in each of the strands, and thus 30 continuous bonded strands were simultaneously formed. A pair of second nip rolls was equipped outside of an outlet of the hot air circulation tunnel. A tension was applied to the monofilaments by using a speed difference between the first nip rolls and the second nip rolls to assist adherence and melt-fusion between the monofilaments heated to a temperature close to the softening point. Running speeds of the first nip rolls and the second nip rolls were 15 mpm and 15.5 mpm, respectively.

Lastly, thus prepared 30 strands formed of 600 monofilaments were arranged in parallel side by side, and the upper ends of the 30 strands were connected by sewing to a connecting band to obtain a weft having a width of 30 cm formed of the 30 strands.

### Comparative Example 2

False hair yarns (in a state of tow) each formed of 600 PVC monofilaments each having a fineness of 45 denier were cut to 30 cm, and the yarns were divided and weighed into 30 bundles, each bundle having a weight of 0.93 g/600 F. These bundles were immersed in a 3 wt % aqueous binder solution (Wet-look Binder 360, SP KOSTECH) for about 5 minutes and dried in a hot air drier of about 95° C. for about 1 hour to prepare a strand bonded by the adhesive.

Lastly, thus prepared 30 strands were arranged in parallel side by side, and the upper ends of the 30 strands were connected by sewing to a connecting band to obtain a weft having a width of 30 cm formed of the 30 strands.

### Example 3

200 PPS monofilaments each having a fineness of 50 denier were measured, taken up, and wound on a winding roll. 30 winding rolls were mounted on a supply die. While the winding rolls were rotated perpendicular to a running direction of the monofilaments to provide twists of 30 rotations/meter (RPM), the monofilaments were released and withdrawn from the winding rolls. Here, the 200 monofilaments being withdrawn from one of the winding rolls were collected and passed through a guide roll to come out as one strand. Thus, the total of 30 strands passed a pair of first nip rolls in parallel. The strands running in parallel were passed through a hot air circulation tunnel (having a tunnel length of about 2 m to about 10 m) in which a temperature was maintained constantly at about 155° C. to melt-bond surfaces of the monofilaments in each of the strands, and thus 30 continuous bonded strands were simultaneously formed. A cross-section of the strands was circular. A pair of second nip rolls was equipped outside an outlet of the hot air circulation tunnel. A tension was applied to the monofilaments by using a speed difference between the first nip rolls and the second nip rolls to assist adherence and melt-fusion between the monofilaments heated to a temperature close to the softening point. Running speeds of the first nip rolls and the second nip rolls were 11 mpm and 12.5 mpm, respectively.

Lastly, thus prepared 30 strands formed of 200 monofilaments were arranged in parallel side by side, and the upper ends of the 30 strands were connected by sewing to a connecting band to obtain a weft having a width of 30 cm formed of the 30 strands.

### Comparative Example 3

False hair yarns (in a state of tow) each formed of 200 PVC monofilaments each having a fineness of 50 denier was cut to 30 cm, and the yarns were divided and weighed into 30 bundles, each bundle having a weight of 0.35 g/200 F. Here, twists were given to each bundle to maintain a circular cross-section of the monofilaments as much as possible, but it was difficult to immerse the filaments in a binder solution with a support, and thus the twists were abandoned. The bundles were immersed in a 4 wt % aqueous binder solution (Wet-look Binder 360, SP KOSTECH) prepared to maintain the circular shape as much as possible for about 1 minutes and dried in a hot air drier of about 95° C. for about 1 hour to prepare a strand bonded by the adhesive.

Lastly, thus prepared 30 strands were arranged in parallel side by side, and the upper ends of the 30 strands were connected by sewing to a connecting band to obtain a weft having a width of 30 cm formed of the 30 strands.

Evaluation

The bonding effects of the wefts for preparing a wet-look wig obtained from Examples 1 to 3 and Comparative Examples 1 to 3 were compared as follows.

In particular, the wefts were stood in a relative humidity of 50% or lower and at room-temperature for about 2 hours. Next, the strands or the monofilaments of the wefts were put between two palms and scrubbed 300 times with a constant force, and a detached monofilament percent (%) was calculated by counting the monofilaments detached from the wefts. The results are shown in Table 1 under the category “(1) before immersion.”

Next, the new wefts obtained in Examples 1 to 3 and Comparative Examples 1 to 3 were immersed in water of about 30° C. for 10 minutes and removed from the water. Then, the strands or the monofilaments of the wefts were put between two palms and scrubbed 300 times with a constant force, and a detached monofilament percent (%) was calculated by counting the monofilaments detached from the wefts. The results are shown in Table 1 under the category “(2) after immersion.”

TABLE 1

| | (1) Before immersion | | (2) After immersion | | |
|---|---|---|---|---|---|
| | Number of | | Number of | | Number of |
| 300 times | detached | Detach- | detached | Detach- | monofil- |
| scrubbing | monofil- | ment | monofil- | ment | aments |
| test | aments | rate (%) | aments | rate (%) | per bundle |
| Example 1 | 2 | 0.7% | 2 | 0.7% | 300 |
| Comparative | 2 | 0.7% | 244 | 81.3% | filaments |
| Example 1 | | | | | (F) |
| Example 2 | 3 | 0.5% | 3 | 0.5% | 600 |
| Comparative | 4 | 0.7% | 490 | 81.7% | filaments |
| Example 2 | | | | | (F) |
| Example 3 | 0 | 0.0% | 1 | 0.5% | 200 |
| Comparative | 1 | 0.5% | 177 | 88.5% | filaments |
| Example 3 | | | | | (F) |

When the results shown in Table 1 are compared, it may be known that there is almost no difference between the detachment rates of the wefts of Examples 1 to 3 and Comparative Examples 1 to 3 in the scrubbing test before immersion. However, when the results of the scrubbing test after immersion are compared, it may be confirmed that there is almost no difference between the detachment rates of the wefts of Examples 1 to 3, but the detachment rates of the wefts of Comparative Examples 1 to 3 were higher than about 80%, and thus that most of the monofilaments of the wefts of Comparative Examples 1 to 3 were detached. Therefore, it may be confirmed that the wefts using the thermally bonded strands prepared according to the present disclosure have an excellent water-wash resistance, but conventional wefts using bonded strands prepared with a chemical adhesive do not have water-wash resistance.

Also, it is also confirmed that esthetic strands having a circular cross-section are obtained in Example 3, but it is difficult to prepare bonded strands having high esthetics and a circular cross-section when the bonded strands are prepared using a conventional chemical adhesive as in Comparative Example 3. In addition, in Comparative Examples 1 to 3, the bonding process is performed by manual labor that needs considerable labor force and requires an additional chemical binder.

What is claimed is:

1. Strands for wigs comprising a plurality of strands each extended in one direction, teach of the strands comprising:
30 to 8,000 thermoplastic polymer filaments comprising an amorphous organic polymer, a semi-crystalline organic polymer, or an alloy thereof,
wherein each of the filaments has a fineness in a range of 10 denier to 100 denier, and
the filaments are arranged parallel to one another side by side and are bonded to one another by surface fusion,
the strands have water-washability, and
each of the strands is separated from one another.

2. The strands of claim 1, wherein a cross-section of each of the strands is rectangular, circular, triangular, or irregular.

3. The strands of claim 2, wherein each of the strands having a circular cross-section has a rotational twist.

4. The strands of claim 1, wherein each of the strands has curls or a texture in an extending direction.

5. A weft for preparing a wig, the weft comprising:
a connecting band extended in one direction; and
a plurality of strands having one ends connected to the connecting band, wherein the one ends of the strands are sequentially connected to a side of the connecting band along a direction the connecting band is extended,
wherein the strands are extended in one direction, and
each of the strands comprises 30 to 8,000 thermoplastic polymer filaments comprising an amorphous organic polymer, a semi-crystalline organic polymer, or an alloy thereof,
wherein each of the filaments has a fineness of 10 denier to 100 denier, and the filaments are bonded to one another by surface fusion,
the strands have water-washability, and
each of the strands are separated from one another.

6. The weft of claim 5, wherein a cross-section of the strand is circular, elliptical, triangular, rectangular, or irregular.

7. The weft of claim 6, wherein the strands having a circular cross-section have a rotational twist.

8. The weft of claim 5, wherein the strands have curls or a texture in a direction the strands are extended.

9. A wig comprising the strands of claim 1.

10. The strands of claim 9, wherein a cross-section of each of the strands is rectangular, circular, triangular, or irregular.

11. The strands of claim 10, wherein each of the strands having a circular cross-section has a rotational twist.

12. The strands of claim 9, wherein each of the strands has curls or a texture in an extending direction.
